(19) United States
(12) Patent Application Publication
(10) Pub. No.: US 2018/0345622 A1
(43) Pub. Date: Dec. 6, 2018

(54) Cooling Garment

(71) Applicant: Perry Karidis, Simi Valley, CA (US)

(72) Inventor: Perry Karidis, Simi Valley, CA (US)

(21) Appl. No.: 15/996,272

(22) Filed: Jun. 1, 2018

Related U.S. Application Data
(60) Provisional application No. 62/514,827, filed on Jun. 3, 2017.

(51) Int. Cl. B32B 3/26; B32B 5/02; B32B 5/26; B32B 7/12; B32B 3/14; B32B 27/12; B32B 27/34

(52) U.S. Cl. CPC B32B 3/263; B32B 5/02; B32B 5/26; B32B 7/12; B32B 2437/00; B32B 27/12; B32B 27/34; B32B 2307/728; B32B 3/14

(57) ABSTRACT

This invention is directed toward a garment made from two breathable fabric layers sandwiching a flat layer of polyacrylamide segments and a flat layer of Elastobond. Because the layer of polyacrylamide is flat, it creates a cooling garment that a) has polyacrylamide in a pattern over the entire garment, and b) dries to a flat shape, thereby making storage of the now-compact garment easy and efficient.

### CROSS REFERENCE TO RELATED APPLICATIONS

This application claims priority back to U.S. Provisional No. 62/514,827, filed Jun. 3, 2017, the contents of which are incorporated into this application by reference.

### STATEMENT REGARDING FEDERALLY SPONSORED RESEARCH OR DEVELOPMENT

This invention was not federally sponsored.

### BACKGROUND OF THE INVENTION

### Field of the Invention

This invention relates to the general field of cooling garments, more specifically to a cooling garment utilizing a layer of polyacrylamide sheeting and a layer of Elastobond in between two fabric layers. The device works by soaking it in water such that the polyacrylamide layer becomes saturated with water, then wringing the excess water out and allowing the breathable fabric to create evaporative cooling. Because the polyacrylamide layer is flat, when not in use (saturated with water), it is relatively flat and easy to store when compared with the prior art, which required pockets of polyacrylamide crystals which resulted in a “quilted”, three-dimensional pattern even when the garment was dry. A preferred embodiment of the invention provides that the polyacrylamide layer is cut into a decorative and/or functional pattern, and then the polyacrylamide sections are laid out on the Elastobond and the fabric layers are heat-treated to adhere to each other through the Elastobond.

Cooling garments have been known in the prior art for some time, and the use of polyacrylamide crystals is also known for their water retaining quantities. However, these crystals are roundish pieces of minerals, and, as such, cannot be easily incorporated into a garment, so the prior art taught concentrating these crystals into small “pockets” that where then heat-pressed or otherwise constrained into a pattern, where the pockets of polyacrylamide crystals were separated from one another by sections where the two layers of breathable fabric were stitched or heat sealed directly together, creating a quilted pattern of polyacrylamide crystals.

These garments were semi-effective, but because a substantial amount of the garment was merely two fabric layers connected by stitching, the actual evaporative surface area was far from 100% of the total garment. Another problem presented by the quilted appearance was that the pockets of crystals did not shrink in height as the water evaporated, leaving behind a garment with obvious quilted sections that made for a large garment with difficult storage options.

Thus, there has existed a long-felt need for a garment that uses polyacrylamide to cool the person, animal or machine over which the garment is placed, but where the polyacrylamide is distributed over the entire garment, and where the garment is easy to store once it is dry. There is also a need for a garment where the polyacrylamide is sectionally distributed, but still will dry to a flat configuration, also avoiding the prior art problem of storing a quilted garment.

The current invention provides just such a solution by having a flat layer of polyacrylamide that, when wet expands and begins to cool through evaporative cooling, but when dry, shrinks back down to a flat configuration. This makes storage of the garment much easier than with the prior art “quilted” versions. Second, because the polyacrylamide sheet can be sandwiched throughout the garment, it provides cooling over the entire garment rather than just the “quilted” sections. Adhering the polyacrylamide layer to the two outlying fabric layers is a layer of Elastobond.

In a preferred embodiment, sections of polyacrylamide are laid out on the Elastobond to create a pattern of polyacrylamide sections. This can be a functional arrangement, to provide cooling specifically for a purpose or industry, and/or decorative to provide advertising for a particular brand. By being able to lay out exactly where the cooling cells are located, a designer can truly customize a cooling garment for the industry—and indeed even the person—that the garment is designed for.

### OBJECTS OF THE INVENTION

It is therefore an object of the present invention to provide a garment including a layer of polyacrylamide that extends over the entire surface of the garment.

Another object of the invention is to provide a garment that when dry is easy to fold and store.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### REFERENCE NUMBERS USED

1. Polyacrylamide layer

2. Fabric layers

3. Elastobond layer

4. Direction of evaporation

5. Section of polyacrylamide

6. Space

7. First-to-second space

8. First Segment

9. Second Segment

### BRIEF DESCRIPTION OF THE FIGURES

One preferred form of the invention will now be described with reference to the accompanying drawings.

FIG. 1 is a side view of the three layers of the garment before they are heat-welded together.

FIG. 2 is a side is a side view of the three layers of the garment after they have been heat-welded together but before it has been immersed in water.

FIG. 3 is a side view of the three layers of the garment after it has been immersed in water.

FIG. 4 is a side, sequential view of a garment with sectional areas of polyacrylamide, from the construction to a wet cycle.

FIG. 5 is a side view of a garment with sectional areas of polyacrylamide, where the sectional areas are all equal.

FIG. 6 is a side view of a garment with sectional areas of polyacrylamide, where the sectional areas are not equal.

### DETAILED DESCRIPTION OF THE FIGURES

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

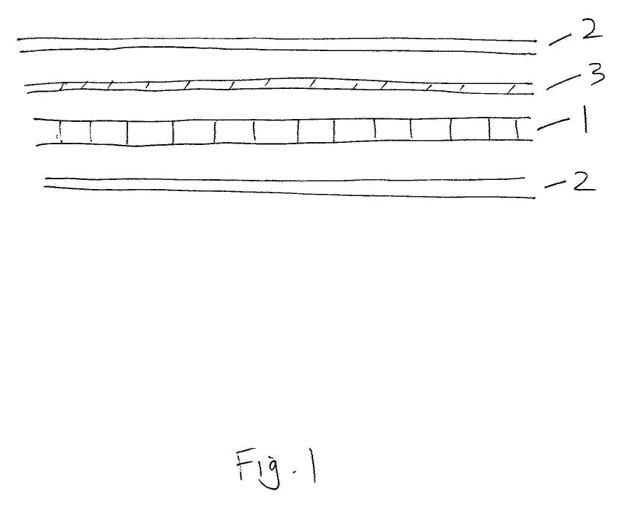

FIG. 1 is a side view of the three layers of the garment before they are heat-welded together. The polyacrylamide layer 1, is sandwiched in between two fabric layers 2. A layer of Elastobond 3 secures the fabric layers 2 and the polyacrylamide layer 1 to each other.

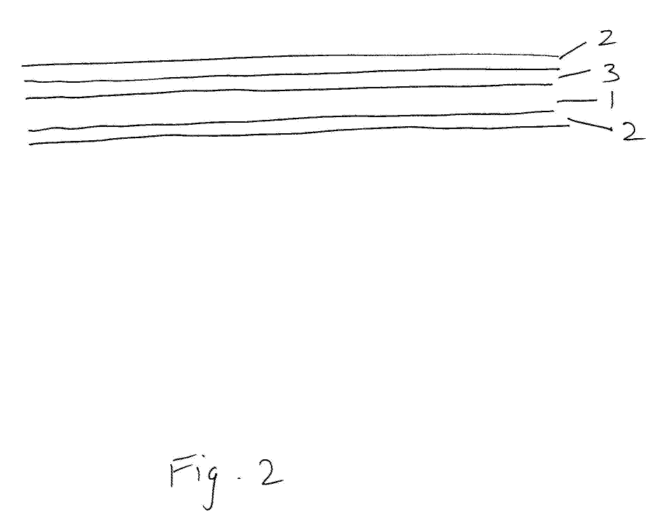

FIG. 2 is a side is a side view of the three layers of the garment after they have been heat-welded together but before it has been immersed in water. The garment is relatively flat, with no pockets of polyacrylamide crystals.

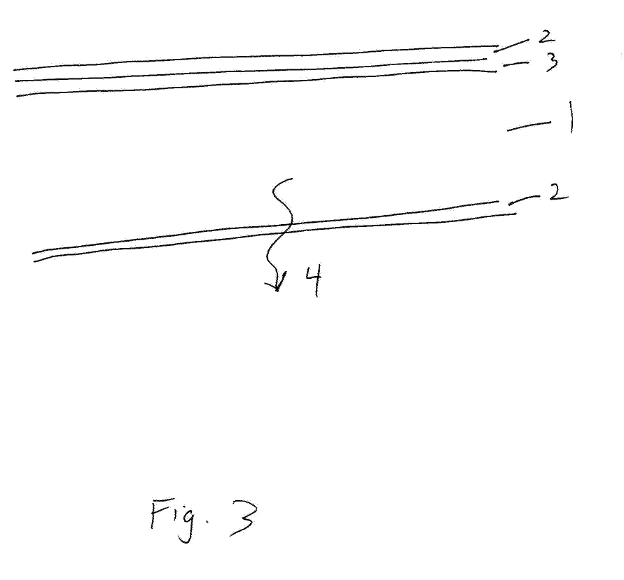

FIG. 3 is a side view of the three layers of the garment after it has been immersed in water. The polyacrylamide layer 1 has expand greatly, and water molecules are turning from an aqueous state to a gas state in direction 4.

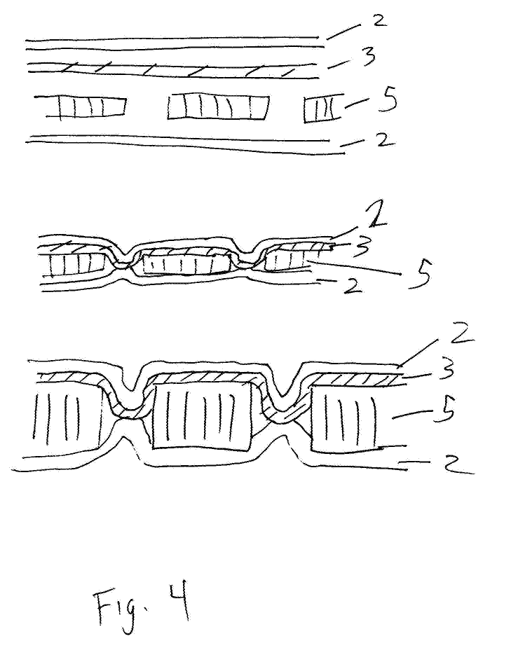

FIG. 4 is a side, sequential view of an embodiment of the invention where the polyacrylamide has been die-cut into specific shapes and arranged on certain parts of the garment to provide selective cooling. The polyacrylamide section 5 is bounded by the connection between the two fabric layers 2, which are connected to each other through the heat-treated Elastobond layer 3. This allows for a garment to be custom-tailored for a specific use in a specific industry, even to the extent of placing the polyacrylamide sections to create a logo or spell a brand name.

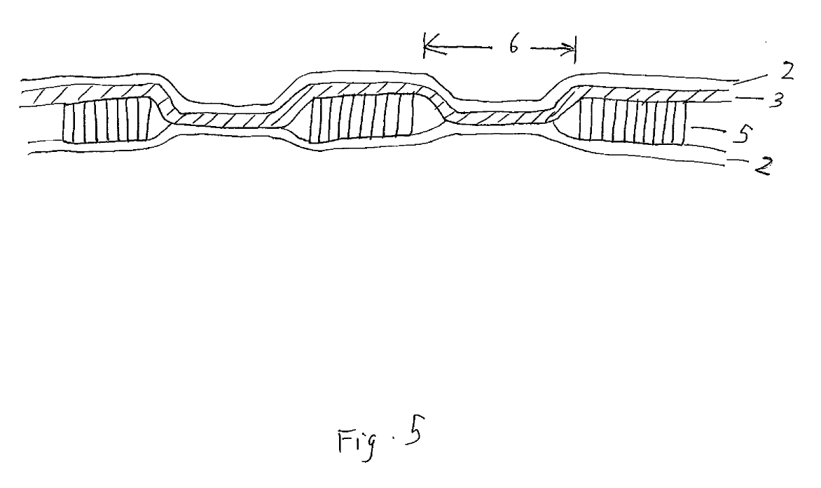

FIG. 5 is a side view of a garment with sectional areas of polyacrylamide, where the sectional areas are all equal. The segments 5 have a space 6 that separates them from other segments 5, thereby creating a pattern in the fabric from which the garment is made.

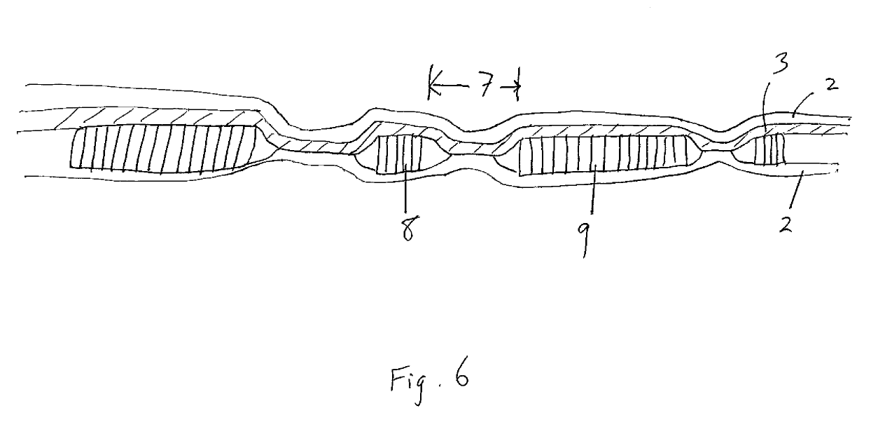

FIG. 6 is a side view of a garment with sectional areas of polyacrylamide, where the sectional areas are not equal. In this figure, two different sizes of segments are used: a first segment 8 and a second segment 9. The distance between them is called the first-to-second space 7. The use of more than one size of segment allows for the creation of more complex patterns. A particularly preferred embodiment of the invention calls for a first segment to be made in the shape or letters or a logo, with the second segment creating a decorative pattern around the first segment(s).

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

1. A device for cooling, consisting of: two layers of fabric, a layer of polyacrylamide, and a layer of Elastobond, where the two layers of fabric comprise an upper fabric layer and a bottom fabric layer, and where the layer of polyacrylamide and the layer of Elastobond are above the bottom fabric layer and below the upper fabric layer, where the device is treated by a quantity of heat to fuse the two layers of fabric, the layer of polyacrylamide, and the layer of Elastobond to each other to create a cooling garment, where the two layers of fabric are water-permeable, where the layer of polyacrylamide is not continuous through the entire device, where the layer of polyacrylamide comprises more than 1 individual section of polyacrylamide, such that the two layers of fabric bond and the layer of Elastobond fuse together to create one or more pockets of polyacrylamide, where after being exposed to water, the one or more pockets of polyacrylamide expands, where the one or more pockets of polyacrylamide layer returns to a flat condition after it has evaporated all of its water.

2. The device of claim 1, where the one or more pockets of polyacrylamide is in the shape of a logo.

3. The device of claim 1, where there are at least 20 pockets of polyacrylamide and the at least 20 pockets of polyacrylamide form a decorative pattern on the cooling garment.

4. The device of claim 1, where there are at least 20 pockets of polyacrylamide and the at least 20 pockets of polyacrylamide form a decorative pattern on the cooling garment, and where at least 5 of the at least 20 pockets of polyacrylamide are in the shape of a first pattern, and at least 5 of the at least 20 pockets of polyacrylamide are in the shape of a second pattern, and where the first pattern is different from the second pattern.

5. A device for cooling, comprising: two layers of fabric, one layer of polyacrylamide, and a layer of Elastobond, where the two layers of fabric comprise an upper fabric layer and a bottom fabric layer, and where the layer of polyacrylamide and the layer of Elastobond are above the bottom fabric layer and below the upper fabric layer, where the device is treated by a quantity of heat to fuse the two layers of fabric, the layer of polyacrylamide, and the layer of Elastobond to each other to create a cooling garment, where the two layers of fabric are water-permeable.

6. The device of claim 6, where the layer of polyacrylamide is continuous through the entire device.

7. The device of claim 7, where the layer of polyacrylamide is not continuous through the entire device.

8. The device of claim 7, where the layer of polyacrylamide comprises more than 1 individual section of polyacrylamide, such that the two layers of fabric bond and the layer of Elastobond fuse together to create one or more pockets of polyacrylamide, where after being exposed to water, the one or more pockets of polyacrylamide expands, where the one or more pockets of polyacrylamide layer returns to a flat condition after it has evaporated all of its water.

9. The device of claim 8, where the one or more pockets of polyacrylamide is in the shape of a logo.

10. The device of claim 8, where there are at least 20 pockets of polyacrylamide and the at least 20 pockets of polyacrylamide form a decorative pattern on the cooling garment.

11. The device of claim 10, where there are at least 20 pockets of polyacrylamide and the at least 20 pockets of polyacrylamide form a decorative pattern on the cooling garment, and where at least 5 of the at least 20 pockets of polyacrylamide are in the shape of a first pattern, and at least 5 of the at least 20 pockets of polyacrylamide are in the shape of a second pattern, and where the first pattern is different from the second pattern.

12. A fabric for cooling, comprising: two layers of fabric, one layer of polyacrylamide, and a layer of Elastobond, where the two layers of fabric comprise an upper fabric layer and a bottom fabric layer, and where the layer of polyacrylamide and the layer of Elastobond are above the bottom fabric layer and below the upper fabric layer, where the device is treated by a quantity of heat to fuse the two layers of fabric, the layer of polyacrylamide, and the layer of Elastobond to each other to create a cooling garment, where the two layers of fabric are water-permeable.

13. The device of claim 12, where the layer of polyacrylamide is not continuous through the entire device.

14. The device of claim 13, where the layer of polyacrylamide comprises more than one individual section of polyacrylamide where each of the more than one individual sections of polyacrylamide has four sides, such that the two layers of fabric bond and the layer of Elastobond fuse together to create one or more pockets of polyacrylamide, where after being exposed to water, the one or more pockets of polyacrylamide expands, where the one or more pockets of polyacrylamide layer returns to a flat condition after it has evaporated all of its water.

15. The device of claim 13, where there are at least 20 pockets of polyacrylamide and the at least 20 pockets of polyacrylamide form a decorative pattern on the cooling garment.

16. The device of claim 13, where there are at least 20 pockets of polyacrylamide and the at least 20 pockets of polyacrylamide form a decorative pattern on the cooling garment, and where at least 5 of the at least 20 pockets of polyacrylamide are in the shape of a first pattern, and at least 5 of the at least 20 pockets of polyacrylamide are in the shape of a second pattern, and where the first pattern is different from the second pattern.

17. The device of claim 16, where each of the at least 5 of the at least 20 pockets of polyacrylamide in the shape of a first pattern have a first width and a first length, and where each of the least 5 of the at least 20 pockets of polyacrylamide in the shape of a second pattern have a second width and a second length, and where a first-to-second distance is defined by a length between one of the at least 5 of the at least 20 pockets of polyacrylamide in the shape of a first pattern, and one of the least 5 of the at least 20 pockets of polyacrylamide in the shape of a second pattern, and where the first-to-second distance is at least 75% greater than each of the first width, the first length, the second width and the second length.

18. The device of claim 17, where the first width is at least 50% larger than the second width, and the first length is at least 25% larger than the second length.

19. The device of claim 13, where there are at least two pockets of polyacrylamide, and there is a space defined by a distance between a first edge of one of the at least two pockets of polyacrylamide to a second edge of another of the at least two pockets of polyacrylamide, and where the each of the more than one individual section of polyacrylamide has a length and a width, and where the space is at least 40% smaller than both the width and the length of the more than one individual section of polyacrylamide.

20. The device of claim 13, where there are at least one first segment of polyacrylamide, at least one second segment of polyacrylamide, at least one third segment of polyacrylamide, and where the first segment has a first segment shape, and the second segment has a second segment shape, and the third segment has a third segment shape, and where the first segment shape is different from the second segment shape and the third segment shape, and where the second segment shape is different from the third segment shape.
